(19) United States
(12) Patent Application Publication
(10) Pub. No.: US 2002/0114480 A1
(43) Pub. Date: Aug. 22, 2002

(54) Playpen having facility for coaxing infant

(76) Inventors: Er-Jui Chen, Feng-Shan City (TW); Chih-Jung Chang, Chia-I City (TW); Pao-Shan Huang, Tai Pao City (TW)

Correspondence Address: LAW OFFICE OF LIAUH & ASSOC., 4224 WAIALAE AVE, STE 5-388, HONOLULU, HI, 96816

(21) Appl. No.: 09/792,214

(22) Filed: Feb. 20, 2001

(51) Int. Cl. H04R 1/02; A47D 7/00; H04R 9/06; A47D 13/06

(52) U.S. Cl. 381/333; 381/386; 381/388; 5/93.1; 5/904

(57) ABSTRACT

A playpen having facility for coaxing infant, utilizes a framing structure to fold, store and support the playpen itself. The framing comprises a vertical shaft set utilized to construct the legs of the playpen, a lower shaft set utilized to construct the bottom of the playpen and an upper shaft set utilized to support the upper edges of the playpen. The upper end of every vertical shaft has a corner jacket, the two ends of the corner of the jacket can be utilized to pivot to the upper shaft set to prop up the upper edge of a textile cloth mat of the playpen, and the corner jacket itself can be utilized to construct a cover of the coaxing facilities for receiving a recording, broadcast, light and battery and sensing-infant's-cry automatic coaxing facility. The vertical shafts that construct the legs of the playpen can be closed up normally to store the playpen conveniently when the playpen is folded through the combination the cover receiving the coaxing facility and the corner jacket.

### TECHNICAL FIELD

The present invention is a playpen having facility for coaxing infant, more particularly to a playpen having infant-coaxing facilities combined with the playpen body, it can emits voice, light and vibration when infant is crying, and vertical shafts, which construct bed feet, can close up normally, conceal and protect the coaxing facilities automatically.

### BACKGROUNDS OF THE PRESENT INVENTION

The designs of facilities for coaxing infant are very much, their functions are nothing but distributing music or mother's voice to let an infant relax and stop crying when an infant wakes up suddenly and cries, so as to soothe a mother and babysitter's physical and mental burden. Such as U.S. Pat. No. 5,452,274 “Sound-activated Playback Device”, invented by Barbara J. Thompson, is a coaxing facility whose speaker switch is driven by an infant voice. But such of facility is easily to be played by an infant's or dropped down to the ground to cause damage when it is in use.

U.S. Pat. No. 5,774,861 “Mirror and Light Box Assembly”, invented by Donald Specyor, provides a light box, enabling an infant to see its mother's picture and to hear its mother's voice in order to soothe its mood to stop crying. But such kind of coaxing facility is hung at a rail, it is still easy to be caught by an infant's hands to play and to be dropped to the floor to cause damage as the figures shown in the drawings of the patent.

Of course, coaxing facilities is not necessary to be installed with an automatic sensing device in them. A conventional toy uses a exposed string for an infant to pull a spring therein, the spring will drive a roller to move a vibration spring plate set to yield music via vibration, it can be counted as a coaxing facility. Such kind of facility still needs a clip or hanger to fix it at the top thereof.

Taking care an infant, besides the above-mentioned coaxing facility is needed, parents may usually buy a playpen for infant to use to make sure of its safety on sleeping or playing alone. If an infant has the playpen to protect it, mother and babysitter can set their mind at ease to do their housekeeping when the infant is sleeping or playing alone. However, for the reason to save the occupied space for storing the playpen, the most popular product at the present time is a foldable playpen, such as U.S. Pat. No. 5,367,725 “Playpen Structure”, invented by Tsai-Lin Tsai, is one of them. This kind of playpen can fold and erect all the shaft sets one by one on folding. But the trouble is that if coaxing facilities are hung around the edges of the playpen, it cannot be folded directly; in another word, if the facilities is forgotten to take away on folding, the facilities will drop to the floor to cause damage.

### SUMMARY OF THE PRESENT INVENTION

The main object of the present invention is to provide a design for integrating coaxing facilities and a playpen to be a unitary structure. It not only can utilize the playpen to cover and protect the coaxing facilities on storing, but also can prevent them from damage on using when an infant takes them to play.

For the above-mentioned purpose, the present invention displays a playpen that utilizes a framing structure to fold, store and support the playpen itself. The framing comprises a vertical shaft set utilized to construct the legs of the playpen, a lower shaft set utilized to construct the bottom of the playpen and an upper shaft set utilized to support the upper edges of the playpen. The upper end of every vertical shaft has a corner jacket, the two ends of the corner of the jacket can be utilized to pivot to the upper shaft set to prop up the upper edge of a textile cloth mat of the playpen, and the corner jacket itself can be utilized to construct a cover of the coaxing facilities for receiving a recording, broadcast, light and battery and sensing-infant's-cry automatic coaxing facility. The vertical shafts that construct the legs of the playpen can be closed up normally to store the playpen conveniently through the combination the cover, receiving the coaxing facility, and the corner jacket when the playpen is folded.

For the further understanding of the content and characteristics of the present invention, a detailed description accompanying drawings will be shown as following:

### BRIEF DESCRIPTION OF THE DRAWINGS

FIG. 1 is a perspective view of the present invention;

FIG. 2 is a front view of the present invention, showing that a playpen is folded;

FIG. 3 is a top view of the present invention, showing a space relation of a cover of a coaxing facility and a corner jacket when the structure of the present invention is folded;

FIG. 4 is a partial view, showing a cover of a coaxing facility of a first preferred embodiment of the present invention;

FIG. 5 is a partial view, showing a cover of a coaxing facility of a second preferred embodiment of the present invention;

FIG. 6 is a partial view, showing a cover of a coaxing facility of a third preferred embodiment of the present invention;

FIG. 7 is a block diagram of the present invention, showing the operation of units of a coaxing facility.

### DETAILED DESCRIPTION OF THE PREFERRED EMBODIMENT

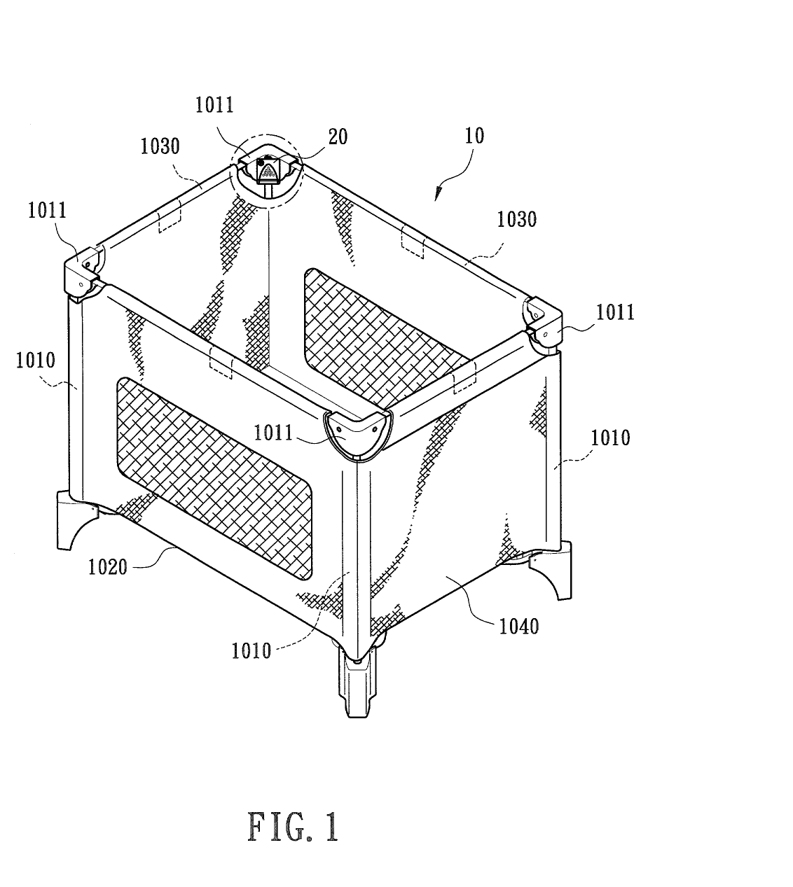

As FIG. 1 shown, a playpen having facility for coaxing infant comprises a framing 10 that can be folded to store or support a textile cloth mat 1040 of the playpen and a cover 20 of an infant coaxing facility. The framing 10 consists a set of vertical shafts 1010 constituting legs of the playpen, a set of lower shafts 1020 constituting the bottom of the playpen and a set of upper shafts 1030 propping up the top edge of the playpen and the shafts of these three sets are all pivoted to each other. The upper end of the vertical shaft 1010 has a corner jacket 1011 thereon, the corner jacket 1011 is utilized to be pivoted to the upper shafts 1030 to prop up the upper edge of the playpen, and to construct a coaxing facility cover 20 to receive a recording, broadcast, light, battery and sensing-infant's-cry automatic coaxing facility. The vertical shafts 1010 can be closed up normally to store the playpen conveniently when the playpen is folded through the combination the cover 20 receiving the coaxing facility and the corner jacket 1011.

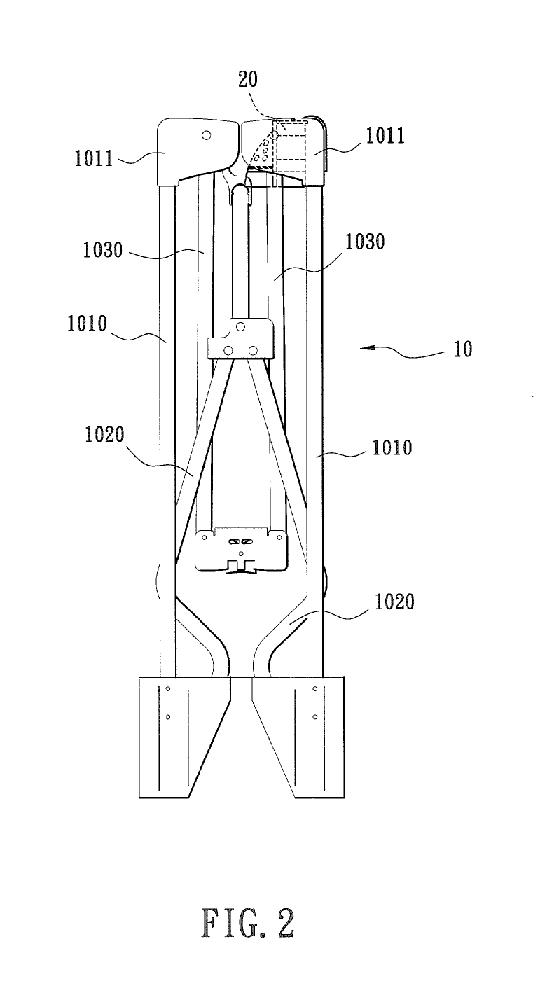

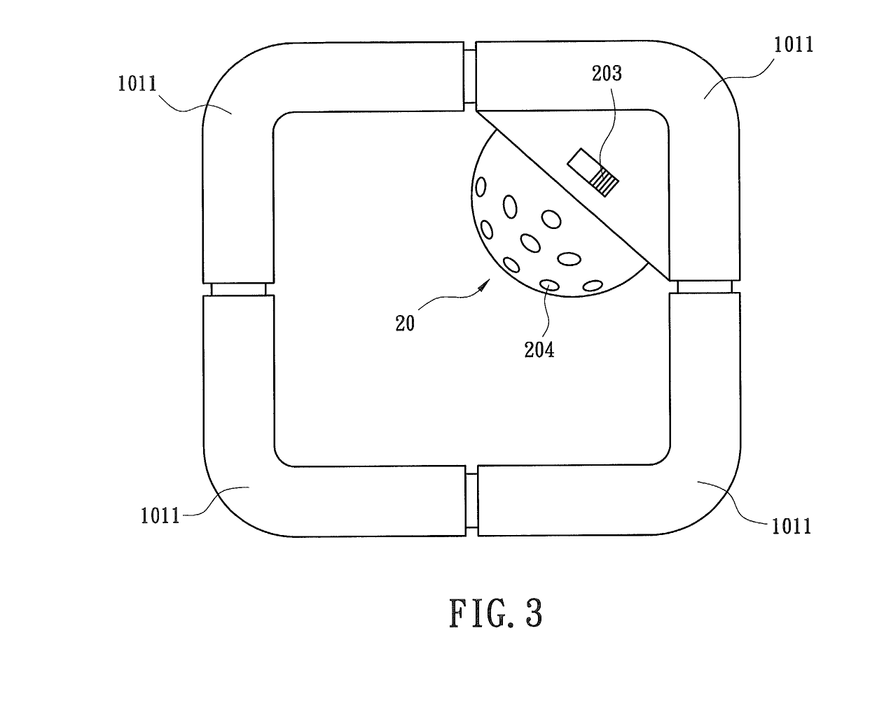

When the playpen is folded, the upper shaft set 1030, lower shaft set 1020 and vertical shaft set 1020 are closed up as FIG. 2 and FIG. 3 shown. Referring to FIG. 3, coaxing facility cover 20 will be covered in the corner jacket 1011 to get protection when the playpen is folded and the corner jacket 1011 is closed normally.

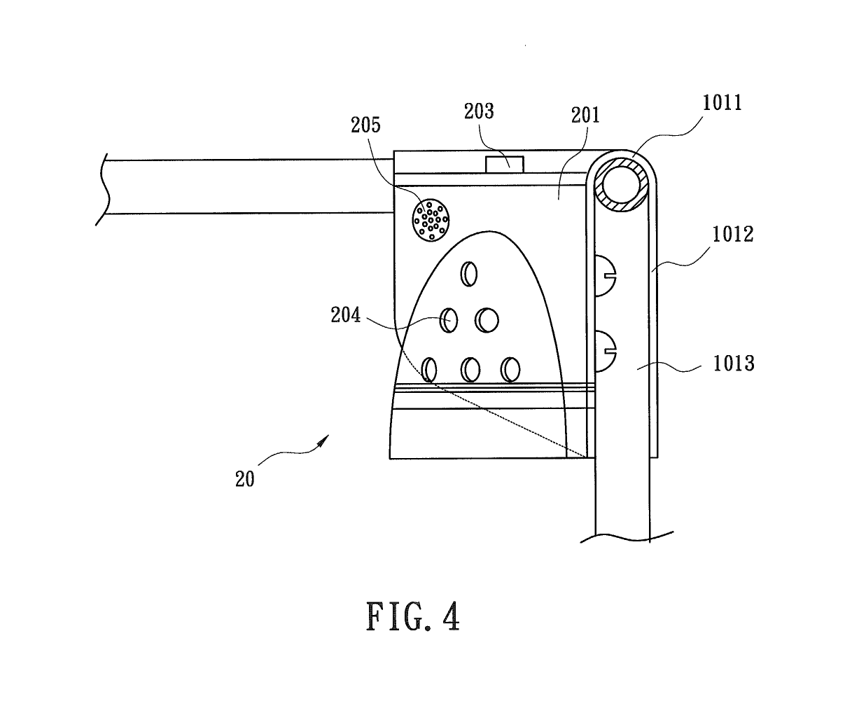

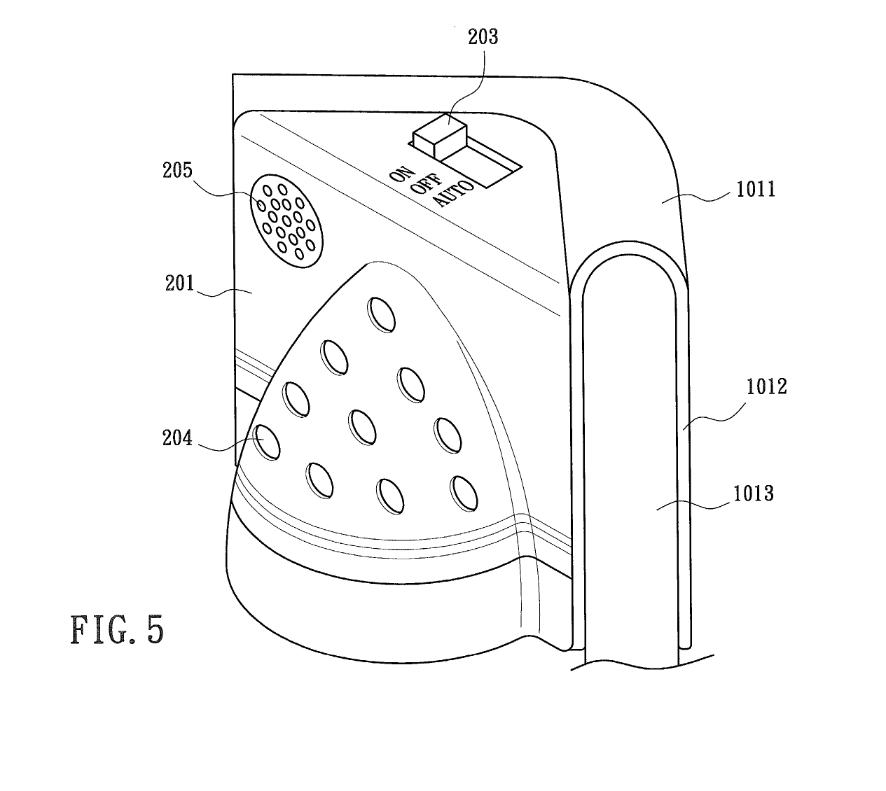

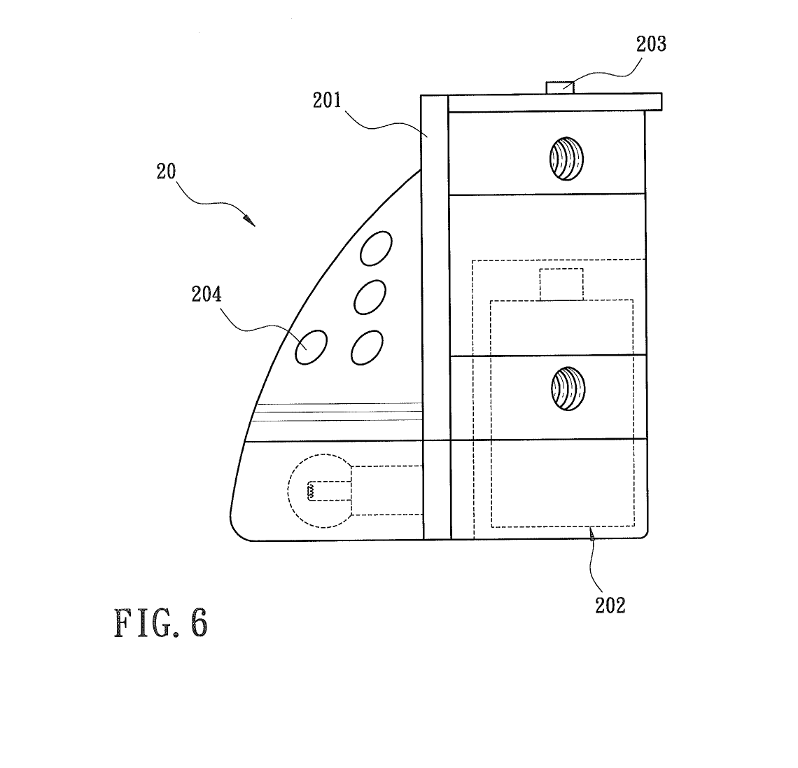

According to what is displayed in the present invention, the manner to let a coaxing facility integrate with the playpen at least includes: as FIG. 5 shown, a section of hanging arm 1012, which is disposed additionally and integrally at two flank sides of the coaxing facility cover 20, constructs a groove 1013, whose opening is downward, together with the two adjacent flank sides of the cover, enabling the coaxing facility cover to have the normal functions of the corner jacket 1011 by pivoting the groove 1013 to the upper shaft set 1030. Or as FIG. 4 shown, the coaxing facility cover 20 is locked on any corner jacket 1011 with screws. The inner structure of the coaxing facility cover 20 can be seen from FIG. 6, it at least includes a main body 201, a battery cell that can receive batteries is disposed therein, a switch 203 is disposed at the upper side of the main body 201, the switch 203 can be a three steps switch (OPEN, CLOSE and AUTO), a voice exit 204 and voice inlet 205 are disposed at the front side of the main body 201, a light bulb room 202, which can receive illumination facility such as light bulbs, is further disposed at the bottom of the main body 201.

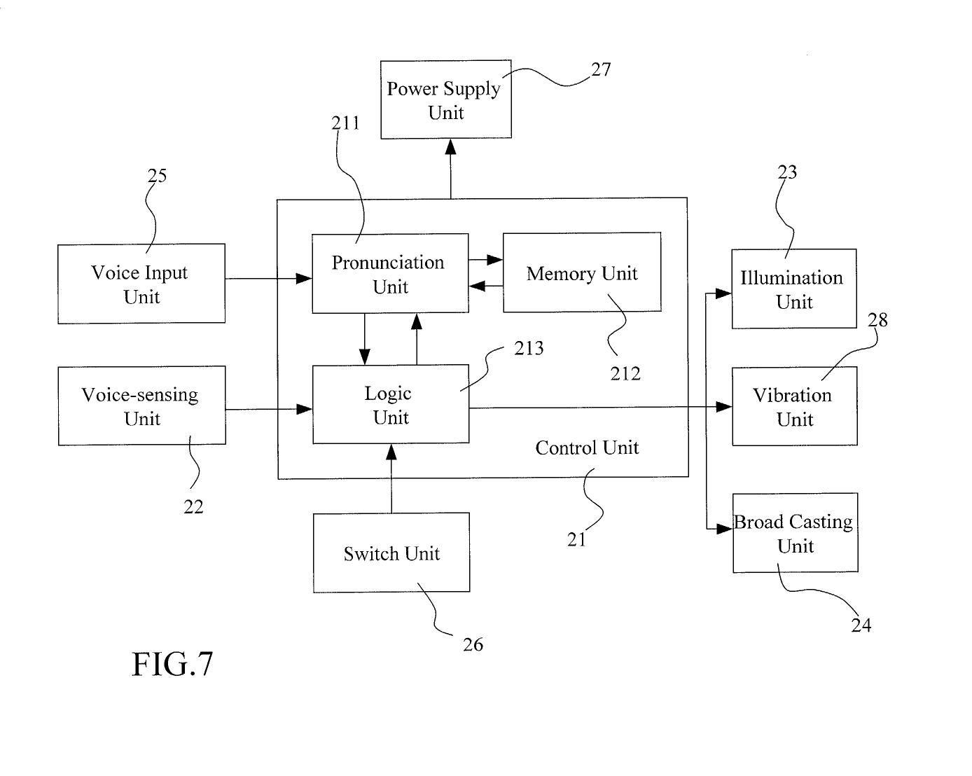

The constitution of the coaxing facility received in the coaxing facility cover 20 can be seen from FIG. 7, the facility at least comprises a control unit 21, a voice sensing unit 22, a illumination unit 23, broadcast unit 24, a voice input unit 25, a switch unit 26 and a power supply unit 27 and etc.

The control unit 21 further comprises a pronunciation unit 211, a memory unit 212 and a logic unit 213. Parents' voice and infant's favorite music can be input into the pronunciation unit 211 (can be a pronunciation IC) via the voice input unit 25 (can be a microphone), and the voices are stored in the memory unit 212 (can be a magnetic tape). The logic unit 213 judges to drive the pronunciation unit 211 to act and connect to the broadcast unit 24 (can be speakers) to broadcast pre-recorded voices via the control of the switch unit 26 or the condition of the outside voice received by the voice sensing unit 22 and to switch on the illumination unit 23 (light bulb) to provide illumination. The voice-sensing unit 22 can transfer an infant's sound to an electric signal, and input the electric signal into the logic unit 213. The switch 26 at least has three settings, i.e. switch on (OPEN), switch off (CLOSE) and sense (AUTO). When the switch unit 26 is switched to “OPEN”, the illumination unit 23 is driven via the control unit 21, but the control unit 21 doesn't accept the signal transmitted from the voice-sensing unit 22. When the switch unit is switched to “CLOSE”, the coaxing facility doesn't make any movements. When the switch unit 26 is switched to “AUTO”, both the illumination unit 23 and the broadcast unit 24 don't make any movements, but the control unit 21 will drive the illumination unit 23 and the broadcast unit 24 to act, if the control unit 21 receives the audio frequency signal transmitted from the voice-sensing unit 22. And electric power is supplied to the infant coaxing facility through the power supply unit 27 (a direct current style of an alternating current style).

When using the infant coaxing facility of the present invention, parents may first speak to the voice inlet 205, and the infant coaxing voice will be transmitted to the pronunciation unit 211 through the voice input unit 25, then recorded in the memory unit 212. When the parents want to leave the infant for a while, the switch 203 can be switched to “AUTO”, if the infant cries, the voice-sensing unit 22 will transfer the infant's voice into audio signal, then transmit to the control unit 21. The control unit 21 can drive the pronunciation unit 211 to broadcast the voice that is recorded in the memory unit 212 via broadcast unit 24. Meanwhile, the control unit 21 also switches on the illumination unit 23 to supply light illumination. The switch 203 may be switched to “OFF” when the parents come back to the infant.

Besides the coaxing functions of the voice and illumination, a vibration unit 28 may further be installed, that vibration can let the infant feel comfortable and quiet down. A conventional massager structure can be utilized in the vibration unit 28, such as, a eccentric rotator is rotated by a motor to generate vibration, the vibration will be transmitted to the lower shaft set 1020 that constructs the bottom of the playpen and the textile cloth mat 1040 via the coaxing facility cover 20 and the vertical shaft 1010, enabling the infant sleeping on the textile cloth mat 1040 to feel comfortable.

The design to integrate a coaxing facility and playpen according to the present invention, not only can utilize the playpen to cover and protect the coaxing facility, but also can prevent the coaxing facility from damage when the infant takes it down and plays.

It is to be understood that the drawing is designed for purpose of illustration only, and is not intended for use as a definition of the limits and scope of the invention disclosed.

What is claimed is:

1. A playpen having facility for coaxing infant, comprising:
a framing, said framing consisting of a vertical shaft set, a lower shaft set and an upper shaft set; wherein said lower shaft set and vertical shaft set pivot with each other to construct a bottom of said playpen, the upper end of said vertical shaft has a corner jacket, two ends of a corner of said corner jacket is utilized to be pivoted to said upper shaft set to prop up the top end of a textile cloth mat of said playpen;
an infant coaxing facility cover, connected inside said corner of said corner jacket to construct a space for receiving said infant coaxing facility.

2. The playpen of claim 1, wherein said infant coaxing facility comprises a switch, power supply unit and broadcast unit, said power supply unit is utilized to supply needed electric power and said switch is utilized to switch on and off said broadcast unit.

3. The playpen of claim 2, wherein said broadcast unit is a speaker.

4. The playpen of claim 1, wherein said infant coaxing facility comprises a switch, power supply unit and illumination unit, said power supply unit is utilized to supply needed electric power and said switch is utilized to switch on and off said illumination unit.

5. The playpen of claim 4, wherein said illumination unit is a light bulb.

6. The playpen of claim 1, wherein said infant coaxing facility comprises a switch, power supply unit and vibration unit, said power supply unit is utilized to supply needed electric power and said switch is utilized to switch on and off said vibration unit.

7. The playpen of claim 1, wherein said infant coaxing facility further comprises:
a voice-sensing unit, said voice-sensing unit is utilized to sense an infant's crying voice and to emit a electric signal;
a broadcast unit, utilized to broadcast voice;
a control unit, said control unit drives said broadcast unit on receiving said electric signal; and
a power supply unit, utilized to supply needed electric power.

8. The playpen of claim 7, wherein said broadcast unit if a speaker.

9. The playpen of claim 1, wherein said infant coaxing facility further comprises:
a voice-sensing unit, said voice-sensing unit is utilized to sense an infant's crying voice and to emit an electric signal;
an illumination unit, utilized to supply illumination;
a control unit, said control unit drives said broadcast unit on receiving said electric signal; and
a power supply unit, utilized to supply needed electric power.

10. The playpen of claim 9, wherein said illumination unit is a light bulb.

11. The playpen of claim 1, wherein said infant coaxing facility further comprises:
a voice-sensing unit, said voice-sensing unit is utilized to sense an infant's crying voice and to emit an electric signal;
a vibration unit, utilized to supply the movements of a continuous vibration;
a control unit, said control unit drives said broadcast unit on receiving said electric signal; and
a power supply unit, utilized to supply needed electric power.

12. The playpen of claim 7, wherein said control unit comprises:
a pronunciation unit, utilized to process input voice from outside;
a member unit, utilized to store input voice from outside; and
a logic unit, utilized to judge whether said electric signal has been received or not.

13. The playpen of claim 12, wherein said memory unit is a magnetic tape.

14. The playpen of claim 12, wherein said facility further comprises a voice input unit, said voice input unit is connected to said pronunciation unit to receive said input voice from outside.

15. The playpen of claim 12, wherein said facility further comprises a switch unit, said switch unit at least comprises three steps of OPEN, CLOSE and AUTO.

16. The playpen of claim 9, wherein said control unit comprises:
a pronunciation unit, utilized to process input voice from outside;
a member unit, utilized to store input voice from outside; and
a logic unit, utilized to judge whether said electric signal has been received or not.

17. The playpen of claim 16, wherein said memory unit is a magnetic tape.

18. The playpen of claim 16, wherein said facility further comprises a voice input unit, said voice input unit id connected to said pronunciation unit to receive said input voice from outside.

19. The playpen of claim 16, wherein said facility further comprises a switch unit, said switch unit at least comprises three steps of OPEN, CLOSE and AUTO.

20. The playpen of claim 11, wherein said control unit comprises:
a pronunciation unit, utilized to process input voice from outside;
a member unit, utilized to store input voice from outside; and
a logic unit, utilized to judge whether said electric signal has been received or not.

21. The playpen of claim 20, wherein said memory unit is a magnetic tape.

22. The playpen of claim 20, wherein said facility further comprises a voice input unit, said voice input unit id connected to said pronunciation unit to receive said input voice from outside.

23. The playpen of claim 20, wherein said facility further comprises a switch unit, said switch unit at least comprises three steps of OPEN, CLOSE and AUTO.

24. A playpen having facility for coaxing infant, comprising:
an infant coaxing facility cover, a space for receiving an infant coaxing facility being disposed inside said cover, a section of hanging arm, which is disposed at two flank sides of said cover, constructing a groove, whose opening is downward, together with said two flank sides of said cover;
a framing, said framing consisting of a vertical shaft set, a lower shaft set and an upper shaft set; wherein said lower shaft set and vertical shaft set pivot with each other to construct a bottom of said playpen, the upper end of said vertical shaft is connected to said cover, utilizing said groove to be pivoted said upper shaft so that said framing can be folded to store or extended.

25. The playpen of claim 24, wherein said infant coaxing facility comprises a switch, power supply unit and broadcast unit, said power supply unit is utilized to supply needed electric power and said switch is utilized to switch on and off said broadcast unit.

26. The playpen of claim 25, wherein said broadcast unit is a speaker.

27. The playpen of claim 24, wherein said infant coaxing facility comprises a switch, power supply unit and illumination unit, said power supply unit is utilized to supply needed electric power and said switch is utilized to switch on and off said illumination unit.

28. The playpen of claim 27, wherein said illumination unit is a light bulb.

29. The playpen of claim 24, wherein said infant coaxing facility comprises a switch, power supply unit and vibration unit, said power supply unit is utilized to supply needed electric power and said switch is utilized to switch on and off said vibration unit.

30. The playpen of claim 24, wherein said infant coaxing facility further comprises:
a voice-sensing unit, said voice-sensing unit is utilized to sense an infant's crying voice and to emit an electric signal;
a broadcast unit, utilized to broadcast voice;
a control unit, said control unit drives said broadcast unit on receiving said electric signal; and
a power supply unit, utilized to supply needed electric power.

31. The playpen of claim 30, wherein said broadcast unit is a speaker.

32. The playpen of claim 24, wherein said infant coaxing facility further comprises:
a voice-sensing unit, said voice-sensing unit is utilized to sense an infant's crying voice and to emit an electric signal;
an illumination unit, utilized to supply illumination;
a control unit, said control unit drives said broadcast unit on receiving said electric signal; and
a power supply unit, utilized to supply needed electric power.

33. The playpen of claim 32, wherein said illumination unit is a light bulb.

34. The playpen of claim 24, wherein said infant coaxing facility further comprises:
a voice-sensing unit, said voice-sensing unit is utilized to sense an infant's crying voice and to emit an electric signal;
a vibration unit, utilized to supply the movements of a continuous vibration;
a control unit, said control unit drives said broadcast unit on receiving said electric signal; and
a power supply unit, utilized to supply needed electric power.

35. The playpen of claim 30, wherein said control unit comprises:
a pronunciation unit, utilized to process input voice from outside;
a member unit, utilized to store input voice from outside; and
a logic unit, utilized to judge whether said electric signal has been received or not.

36. The playpen of claim 35, wherein said memory unit is a magnetic tape.

37. The playpen of claim 35, wherein said facility further comprises a voice input unit, said voice input unit is connected to said pronunciation unit to receive said input voice from outside.

38. The playpen of claim 35, wherein said facility further comprises a switch unit, said switch unit at least comprises three steps of OPEN, CLOSE and AUTO.

39. The playpen of claim 32, wherein said control unit comprises:
a pronunciation unit, utilized to process input voice from outside;
a member unit, utilized to store input voice from outside; and
a logic unit, utilized to judge whether said electric signal has been received or not.

40. The playpen of claim 39, wherein said memory unit is a magnetic tape.

41. The playpen of claim 39, wherein said facility further comprises a voice input unit, said voice input unit id connected to said pronunciation unit to receive said input voice from outside.

42. The playpen of claim 39, wherein said facility further comprises a switch unit, said switch unit at least comprises three steps of OPEN, CLOSE and AUTO.

43. The playpen of claim 34, wherein said control unit comprises:
a pronunciation unit, utilized to process input voice from outside;
a member unit, utilized to store input voice from outside; and
a logic unit, utilized to judge whether said electric signal has been received or not.

44. The playpen of claim 43, wherein said memory unit is a magnetic tape.

45. The playpen of claim 43, wherein said facility further comprises a voice input unit, said voice input unit id connected to said pronunciation unit to receive said input voice from outside.

46. The playpen of claim 43, wherein said facility further comprises a switch unit, said switch unit at least comprises three steps of OPEN, CLOSE and AUTO.

47. The playpen of claim 1, wherein said infant coaxing facility comprises a spring, a music roller, a set of vibration spring plates and a section of rope, said exposed rope is utilized to pull said spring, enabling said spring to drive said music roller, and said music roller is utilized to move said set of vibration spring plate, then music is generated through vibration of said set of vibration spring plates.

48. The playpen of claim 24, wherein said infant coaxing facility comprises a spring, a music roller, a set of vibration spring plates and a section of rope, said exposed rope is utilized to pull said spring, enabling said spring to drive said music roller, and said music roller is utilized to move said set of vibration spring plate, then music is generated through vibration of said set of vibration spring plates.
